(19) United States
(12) Patent Application Publication
(10) Pub. No.: US 2008/0239152 A1
(43) Pub. Date: Oct. 2, 2008

(54) Sub picture reproducing device, sub picture reproducing method, and sub picture reproducing program

(75) Inventor: Yoko Masuo, Iruma-shi (JP)

Correspondence Address: KNOBBE MARTENS OLSON & BEAR LLP, 2040 MAIN STREET, FOURTEENTH FLOOR, IRVINE, CA, 92614, US

(73) Assignee: Kabushiki Kaisha Toshiba, Tokyo (JP)

(21) Appl. No.: 12/075,211

(22) Filed: Mar. 10, 2008

(30) Foreign Application Priority Data
Mar. 29, 2007 (JP) 2007-086124
Mar. 29, 2007 (JP) 2007-086127

(51) Int. Cl. H04N 9/76

(52) U.S. Cl. 348/600; 348/E09.057

(57) ABSTRACT

According to one embodiment, a sub picture reproducing device comprises an input unit configured such that a sub picture stream provided with display control information including sub picture pixel data to be displayed and color codes to specify display colors of the pixel data, a setting unit configured to set propriety of displays of the sub video pixel data for each of the color codes by operations to the sub picture stream input to the input unit, and a processing unit configured to apply prescribed decode processing to the sub picture stream input to the input unit and to control display inhibition to sub picture pixel data corresponding to color codes to which display inhibition is set by the setting unit.

### CROSS-REFERENCE TO RELATED APPLICATIONS

This application is based upon and claims the benefit of priority from Japanese Patent Application No. 2007-086124, filed Mar. 29, 2007, the entire contents of which are incorporated herein by reference.

### BACKGROUND

1. Field

One embodiment of the invention relates to a sub picture reproducing device, a sub picture reproducing method and a sub picture reproducing program to reproduce a sub picture to be used for a display of a subtitle, menu, etc., for example, in a digital versatile disk (DVD) format.

2. Description of the Related Art

As is known well, as regards the foregoing DVD format, a sub picture has been used to display subtitles to be superimposed on a main picture, a menu to selectively set reproduction content, etc. Especially, preparing sub pictures corresponding to subtitles in a plurality of languages by displaying the subtitles with the sub pictures enables displaying the sub pictures through the selection on the menu.

In this case, under the present circumstances, the sub pictures corresponding to the subtitles in a plurality of languages are each recorded on an optical disk as an independent plurality of sub picture streams. In reproduction, a user may reproduce the sub picture stream corresponding to the selected language by selecting the desired language on the menu.

Meanwhile, in the present situation, as regards a variety of television programs and video commercial message (CM), etc., subtitles are useful to enable the enjoyment of the program itself and to improve the understanding of a viewer. Further, subtitles are generally used with a certain type of content, especially that of a high entertainment value.

Jpn. Pat. Appln. KOKAI Publication No. 10-210504 discloses a configuration which enables a user to freely change the color tone of a sub picture set as a default by making it possible to selectively use a color pallet which has been set on the basis of a color code setting command, and a color pallet which has been freely changed and set by the user.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram for explaining an outline of a disk reproducing device regarding an embodiment of the invention;

FIG. 2 is a view for explaining a structure of a sub picture stream in a DVD format to be reproduced by the disk reproducing device of the embodiment;

FIG. 3 is a view for concretely explaining a sub picture unit header, sub picture pixel data and a display control sequence in the sub picture stream in the DVD format;

FIGS. 4A-4E are views for each explaining a run-length compression rule of sub picture pixel data in the sub picture streams in the DVD format;

FIG. 5 is a view for explaining classification based by the sub picture pixel data in the sub picture stream in the DVD format;

FIG. 6 is a view for explaining a display start timing forced setting command of a display control sequence in the sub picture stream;

FIG. 7 is a view for explaining a display start timing setting command of the display control sequence in the sub picture stream;

FIG. 8 is a view for explaining a display stop timing setting command of the display control sequence in the sub picture stream;

FIG. 9 is a view for explaining a color code setting command of the display control sequence in the sub picture stream;

FIG. 10 is a view for explaining a contrast setting command of the display control sequence in the sub picture stream;

FIG. 11 is a view for explaining a display area setting command of the display control sequence in the sub picture stream;

FIG. 12 is a view for explaining a pixel data (PXD) head address setting command of the display control sequence in the sub picture stream;

FIG. 13 is a view for explaining a color code/contrast changing command of the display control sequence in the sub picture stream;

FIG. 14 is a view for explaining pixel control data of the color code/contrast changing command of the display control sequence in the sub picture stream;

FIG. 15 is a view for explaining line control information of the pixel control data of the color code/contrast changing command of the display control sequence in the sub picture stream;

FIG. 16 is a view for explaining pixel control information of the pixel control data of the color code/contrast changing command of the display control sequence;

FIG. 17 is a view for explaining another PXD head address setting command of the display control sequence in the sub picture stream;

FIG. 18 is a view for explaining a display control end command of the display control sequence in the sub picture stream;

FIG. 19 is a view for explaining of setting by associating color codes and propriety of their displays of a variety of sub pictures in the sub picture stream;

FIG. 20 is a flowchart for explaining a part of principal processing operations of the disk reproducing device of the embodiment of the invention;

FIG. 21 is a flowchart for explaining the rest of the principal processing operations of the disk reproducing device of the embodiment;

FIG. 22 is a view for explaining an example of a concrete operation method of the disk reproducing device of the embodiment;

FIG. 23 is a view for explaining another example of a concrete operation method of the disk reproducing device of the embodiment;

FIG. 24 is a view for explaining a further example of the concrete operation method of the disk reproducing device of the embodiment; and

FIG. 25 is a view for explaining a further example of a concrete operation method of the disk reproducing device of the embodiment.

### DETAILED DESCRIPTION

Various embodiments according to the invention will be described hereinafter with reference to the accompanying drawings. In general, according to one embodiment of the invention, a sub picture reproducing device comprises an input unit configured such that a sub picture stream provided with display control information including sub picture pixel data to be displayed and color codes to specify display colors of the pixel data, a setting unit configured to set propriety of displays of the sub video pixel data for each of the color codes by operations to the sub picture stream input to the input unit, and a processing unit configured to apply prescribed decode processing to the sub picture stream input to the input unit and to control display inhibition to sub picture pixel data corresponding to color codes to which display inhibition is set by the setting unit.

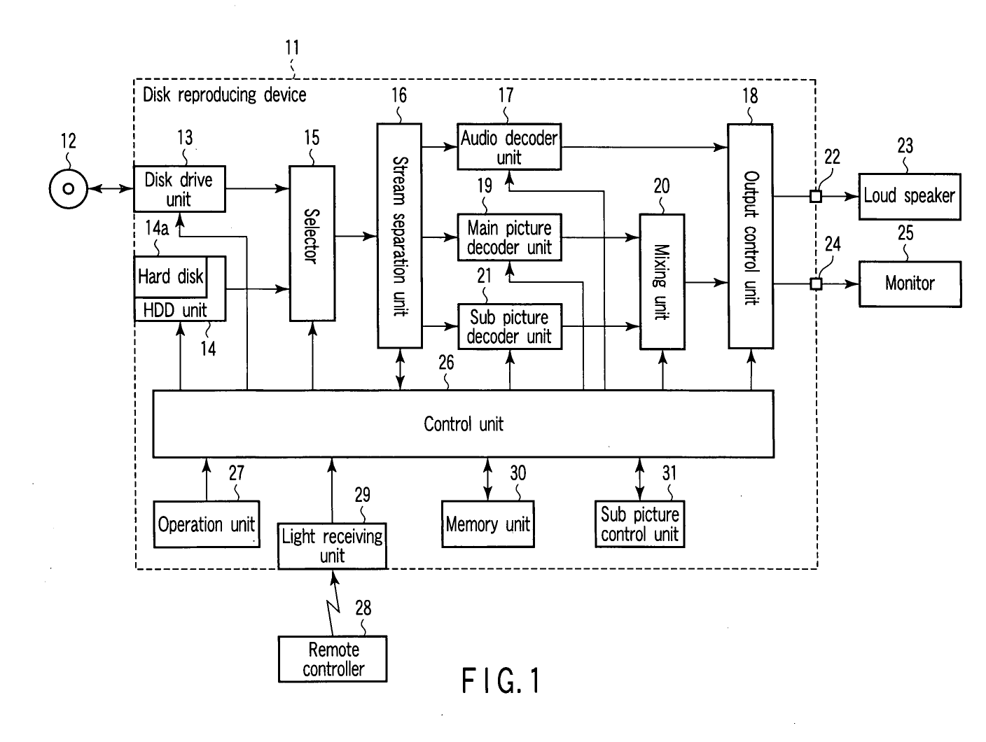

FIG. 1 shows an outline of a disk reproducing device 11 to be described by referring to the embodiments. The device 11 has a disk drive unit 13 which mounts an optical disk 12 such as a DVD [including a high definition (HD) DVD] and reads a recorded stream. The device 11 has a hard disk drive (HDD) unit 14 to read the recorded stream from a hard disk 14a built-in.

Any one of the stream read from the optical disk 12 by the drive unit 13 and the stream read from the disk 14a by the HDD unit 14 is selected by a selector 15 to be supplied to a stream separation unit 16. The separation unit 16 separates an input stream into an audio stream, a main picture stream and a sub picture stream to output them together with system time clock (STC) information.

Of these streams, the audio stream is supplied to an audio decoder unit 17, applied with decode processing to be converted into audio data, and then, supplied to an output control unit 18. The main picture stream is supplied to a main picture decoder 19 to be applied with decode processing, converted into main picture data, and then, supplied to a mixing unit 20.

The mixing unit 20 multiplexes the input main picture data and sub picture data and outputs the multiplexed video data to the control unit 18. The control unit 18 synchronizes the input audio data and video data, outputs the audio data to a loud-speaker 23 from an audio output terminal 22, and outputs the video data to a monitor 25 from a video output terminal 24 to display video.

A control unit 26 integrally controls the whole operation of the device 11, including the aforementioned reproducing operation. The control unit 26 has a central processing unit (CPU) etc. built-in, which receives operation information from an operation unit 27 or operation information transmitted from a remote controller 28 and received by a light receiving unit 29, and controls each unit so as to reflect the operation content.

In this case, the control unit 26 utilizes a memory unit 30. The memory unit 30 includes mainly a read only memory (ROM) with a control program to be executed by the CPU built in the control unit 26 stored thereon, a random access memory (RAM) to provide an operation area for the CPU, and a non-volatile memory to store various items of setting information and control information.

The control unit 26 is connected to a sub picture control unit 31. The control unit 31 (see below for further details) is used for setting the propriety of displays for each color to be displayed of various sub pictures to be displayed in the same sub picture stream (e.g., subtitles etc.), namely for each specified color code. In other words, the control unit 31 controls to display a menu for setting the proprieties of displays of the sub pictures for each color code by a user, and actually displays or does not display the sub pictures on the basis of the content set by the menu.

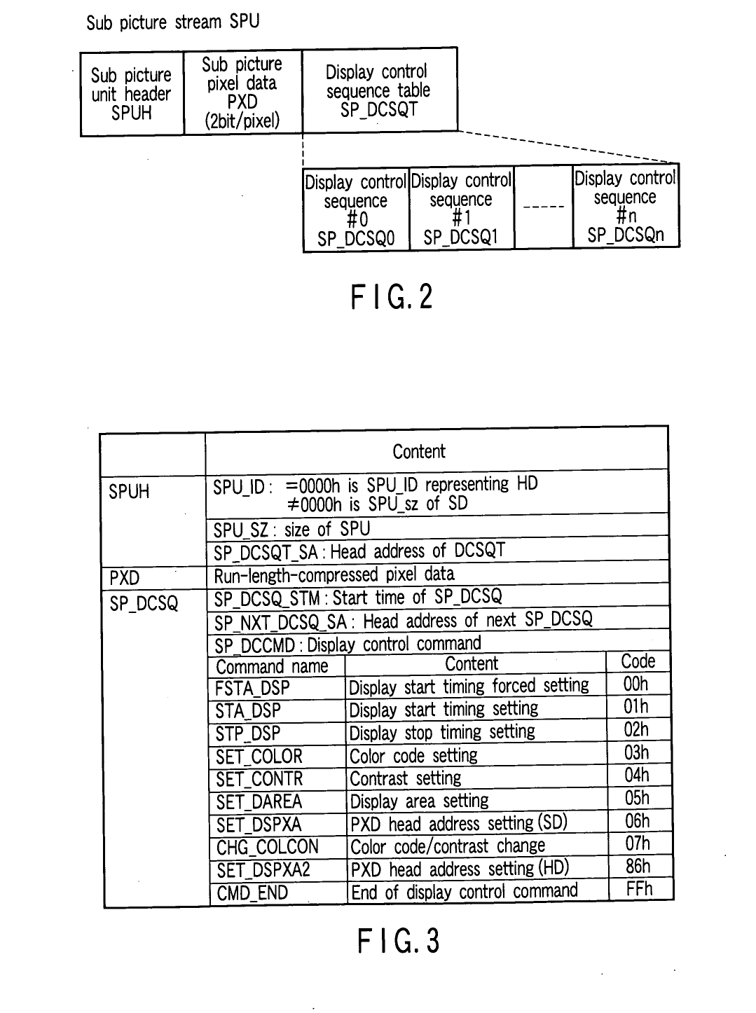

Here, FIG. 2 shows a configuration of one sub picture stream SPU (sub picture unit) in a DVD format. That is, the one stream SPU has a sub picture unit header SPUH at the head, and after this, sub picture pixel data PXD and a sub picture_display control sequence table (SP_DCSQT) including one or more sub picture_display control sequences (SP_DCSQs) are successively continued.

FIG. 3 shows the content of the unit header SPUH, the sub picture PXD, and one of the display control sequence SP_DCSQs. In other words, the unit header SPUH includes information SPU_ID (sub picture unit_identification) showing the kinds of the sub picture streams, information SPU_SZ (sub picture unit_size) showing a size of the sub picture stream, and information SP_DCSQT_SA (sub picture_display control sequence table_start allocation) showing a recording start position.

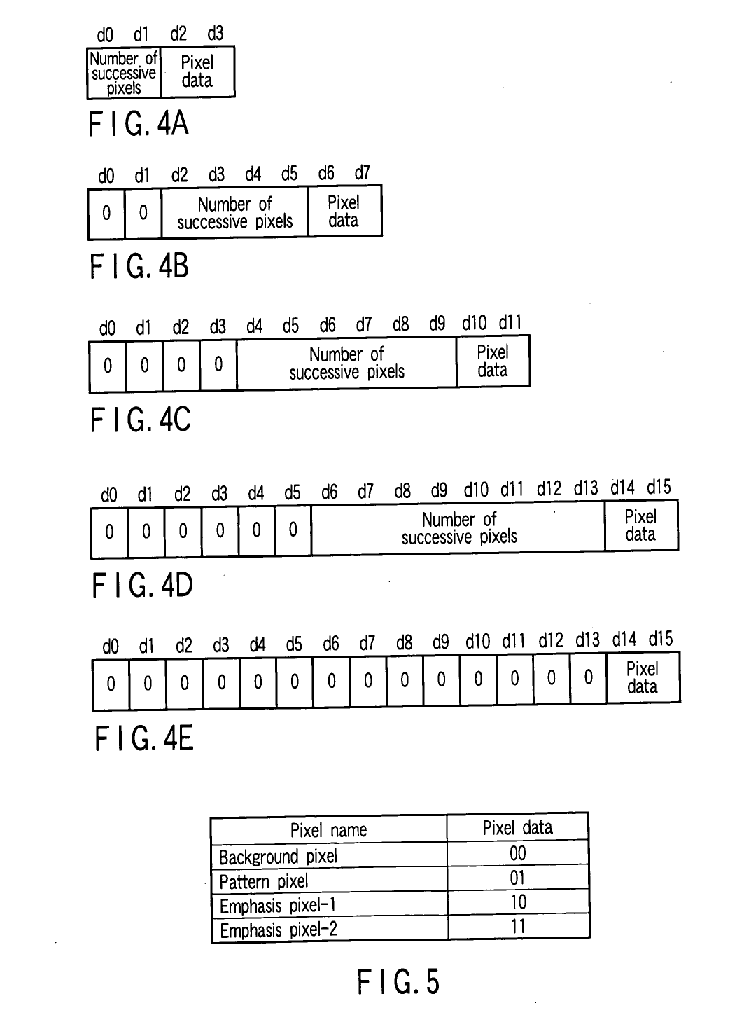

The sub picture PXD is made by applying compression processing, for example, to bit map data of one horizontal line of a two-dimensional display screen in accordance with a run-length compression rule depicted in FIGS. 4A-4E. FIG. 4A shows the case in which the number of successive pixels (sub picture pixels) is one-three, FIG. 4B shows the case in which the number of successive pixels is four-15, FIG. 4C shows the case in which the number of successive pixels is 16-63, FIG. 4D shows the case in which the number of successive pixels is 64-255, and FIG. 4E shows the case in which the pixels continue up to a line end. The sub picture PXD is classified into a background pixel, a pattern pixel, and emphasis pixels 1, 2 by the pixel data in the top 2 bits, as shown in FIG. 5.

Further, the display control sequence SP_DCSQ includes information SP_DCSQ_STM showing a start time of the SP_DCSQ (sub picture_display control sequence_start time), information SP_NXT_DCSQ_SA showing a head address of the next display control sequence SP_DCSQ (sub picture_next_display control sequence_start address), and one or more display control command SP_DCCMDs (sub picture_display control_commands).

The SP_DCCMD includes a display start timing forced setting command FSTA_DSP for forcibly setting display start timing of the sub picture PXD, a display start timing setting command STA_DSP for setting the display start timing of the PXD, a display stop timing setting STP_DSP for setting the display stop timing of the sub picture PXD, a color code setting command SET_COLOR for setting a color code of the sub picture PXD, a contrast setting command SET_CONTR for setting a contrast to the main picture of the sub picture PXD, a display area setting command SET_DAREA for setting a display area of the sub picture PXD, a PXD head address setting command SET_DSPXA for setting the head address of the sub picture PXD in the case of standard definition (SD), a color code/contrast change command CHG_COLCON for setting changes in the color code and the contrast of the sub picture PXD, a PXD head address setting command SET_DSPXA2 for setting the head address of the sub picture PXD in the case of HD, and a display control end command CMD_END for showing the end of the display control command SP_DCCMD.

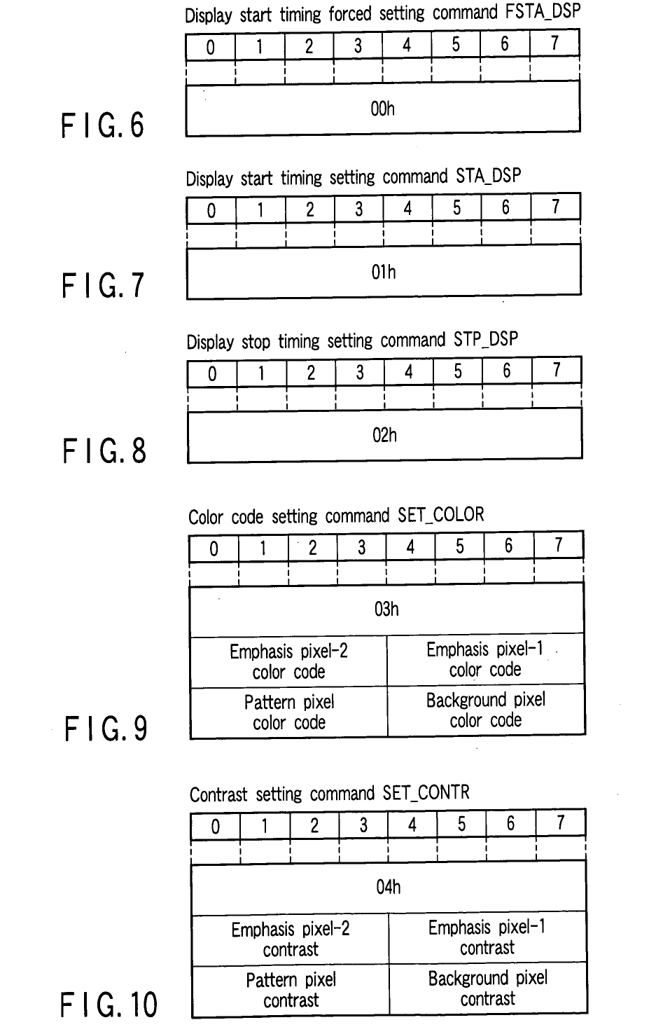

FIG. 6 exemplifies the content (one bite) of the setting command FSTA_DSP. FIG. 7 exemplifies the content (one byte) of the setting command STA_DSP. These commands execute display start control of the sub picture PXD. FIG. 8 exemplifies the content (one byte) of the setting command STP_DSP. This is the command to execute display stop control of the sub picture PXD.

FIG. 9 exemplifies the content (one byte+extended two bytes=three bytes) of the setting command SET_COLOR. This is a command to set the color code of the sub picture PXD. This command enables setting color information by classifying the sub picture into a pattern pixel of a character, a pattern, etc., emphasis pixels in which the pattern pixels are rimmed, and a background pixel, which is a pixel in an area other than the pattern pixel and the emphasis pixel in the area in which the sub picture is displayed.

That is to say, as shown in FIGS. 4A-4E and FIG. 5, the run-length-compressed sub picture PXD is controlled so as to be classified into any one of the pattern pixel, emphasis pixels and background pixel by the pixel data in the top two bits of the sub picture PXD, and to be displayed in colors specified by four-bit color codes in the color code setting command SET_COLOR corresponding to the classified pixels. For instance, if the pixel data in the top two bits of run-length-compressed sub picture PXD is “01b (binary)”, it is classified to the pattern pixel, so that the sub picture PXD is controlled so as to be displayed in the color specified by the four-bit color code in a pattern pixel color code in the setting command SET_COLOR.

FIG. 10 exemplifies the content (one byte+extended two bytes=three bytes) of the contrast setting command SET_CONTR. This command is, similarly to the color code setting command SET_COLOR, a command to set the contrast to the main picture for a specified pixel among four kinds of pixels shown in FIG. 5. For instance, if the top two bits of the run-length-compressed sub picture PXD is “01b”, since the sub picture PXD is classified as the pattern pixel, the sub picture PXD is controlled so as to be displayed with the contrast described by four bits in pattern pixel contrast in the setting command SET_CONTR.

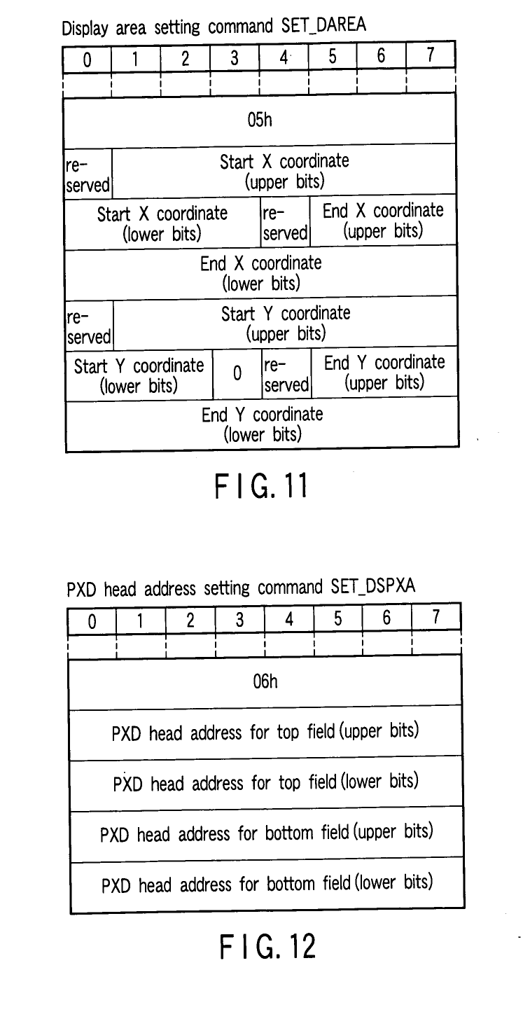

FIG. 11 exemplifies the content (one byte+extended six bytes=seven bytes) of the display area setting command SET_DAREA. This command is one to specify a position (position on X-Y coordinates) displaying the sub picture PXD. FIG. 12 exemplifies the content (one byte+extended four bytes=five bytes) of the PXD head address setting command SET_DSPXA. This is a command to set a head (display start) address of the sub picture PXD with the SD.

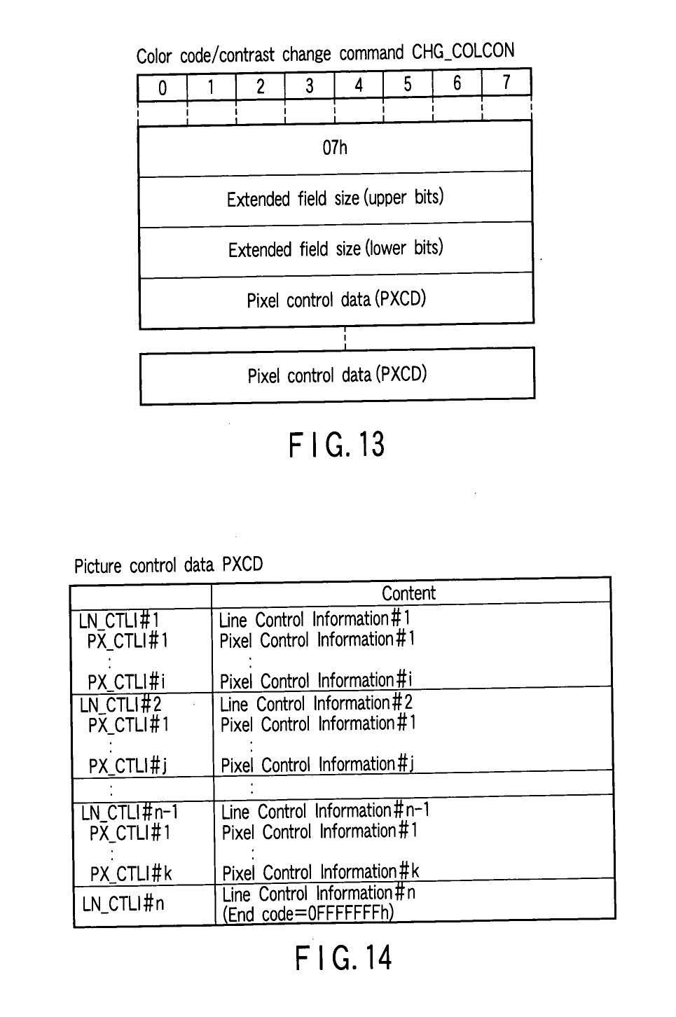

FIG. 13 exemplifies the content [one byte+extended two bytes+pixel control data (PXCD) of the sub picture] of the color code/contrast changing command CHG_COLCON. This is a command to set the change in the color code and the contrast of the sub picture PXD. This command includes the sub picture PXCD and its size (extended field size). The PXCD may be set to one or more items.

FIG. 14 exemplifies each piece of content in the case in which the plurality of items of PXCD exist. Each of the items of the PXCD is composed of line control information LN_CTLI and one or more items of pixel control information PX_CTLI, and an end code “0FFFFFFFh (hexadecimal)” is described in information LN_CTLI of the final pixel control data PXCD.

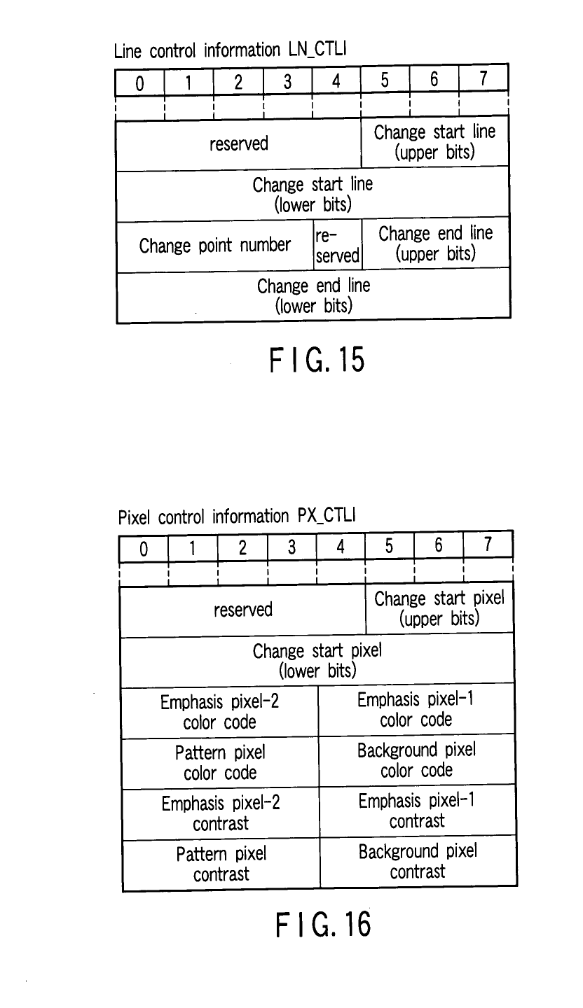

FIG. 15 exemplifies the content of the information LN_CTLI. The information LN_CTLI includes a change start line and a change end line. FIG. 16 exemplifies the content of the pixel control information PX_CTLI. Color code and contrasts of four bit are each described in each of the four kinds of pixels shown in FIG. 5 together with change start pixels in the information PX_CTLI.

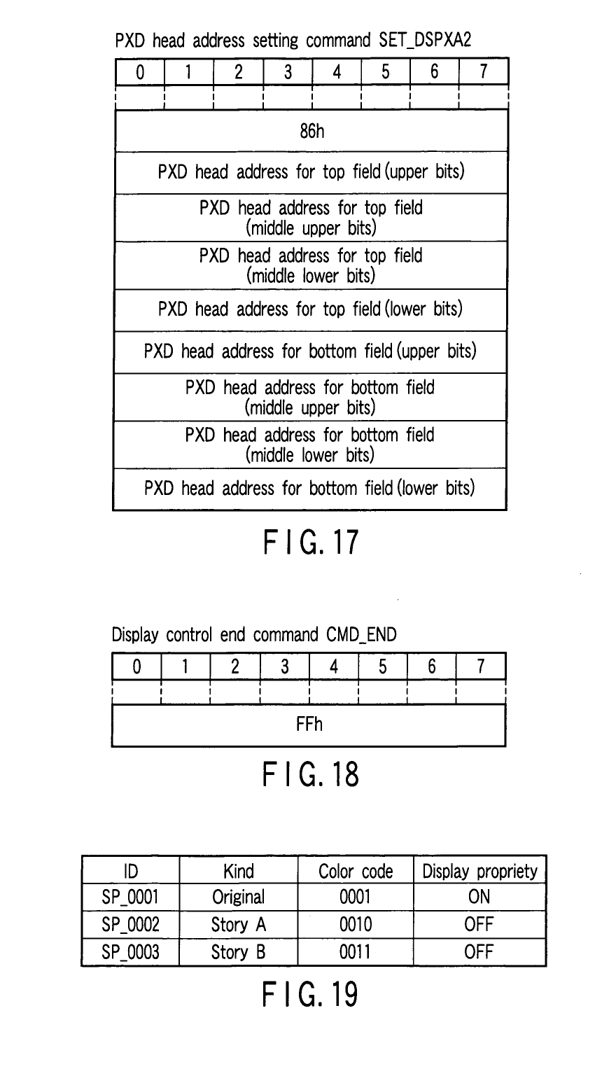

FIG. 17 exemplifies the content (one byte+extended eight bytes=nine bytes) of the PXD head address setting command SET_DSPXA2. This is a command to set a head (display start) address of sub picture PXD with the HD. FIG. 18 shows an example of the content (one byte) of the display control end command CMD_END.

Here, for example, it is assumed that three kinds of sub pictures; a first sub picture, of which the identification information ID is SP_0001 and the kind is original, a second sub picture, of which the identification information ID is SP_0002 and the kind is story A, a third sub picture, of which the identification information ID is SP_0003 and the kind is a story B, are recorded in the same sub picture stream as shown in FIG. 19.

In the embodiment, the sub picture control unit 31 may set color codes and the propriety of their displays for each of the three kinds of sub pictures by associating the color codes with the propriety of the displays. That is, the first sub picture, of which the color code is specified by “0001b”, is set so that the display of the first sub picture is permitted (ON), the second sub picture, of which the color code is specified by “0010b”, is set so that the display of the second sub picture is inhibited (OFF), and the third sub picture, of which the color code is specified by “0011b”, is set so that the display of the third sub picture is inhibited (OFF).

In the case in which a specified color code is set so that the display of the corresponding-sub picture is inhibited, the decoder unit 21 replaces the contrast of the sub picture PXD corresponding to the specified color code by a value which makes the display of the sub picture invisible on the main picture, for example, “1111b”. For instance, in the case in which the color code “0010b” is set so that the display of the corresponding-sub picture is inhibited and a pattern pixel color code in the color code setting command SET_COLOR shown in FIG. 9 is set to “0010b”, the decoder unit 21 replaces the pattern pixel contrast of the contrast setting command SET_CONTR shown in FIG. 10 by “1111b”.

After decoding the sub picture stream with such replacement applied thereto, by being superposed on the main picture data, only the display of the sub picture in the color of which the color code is specified as “0010b” among the identical sub picture streams is not permitted, the sub picture reproducing device may control the propriety of displays of the sub pictures in pixel units, may enhance the degree of freedom of expression of sub pictures, and may contribute to the expansion of video expression.

If the color code/contrast changing command CHG_COLCON exists, it is determined whether the color code, which is set so that the display of the sub picture corresponding to the color code is inhibited, exists in the pixel control information PX_CTLI in the pixel control data PXCD, and if the color code exists, the decoder unit 21 replaces the contrast of the corresponding-pixel in the pixel control information PX_CTLI by the value “1111b” corresponding to the color code of which the corresponding-sub picture is set not to be displayed.

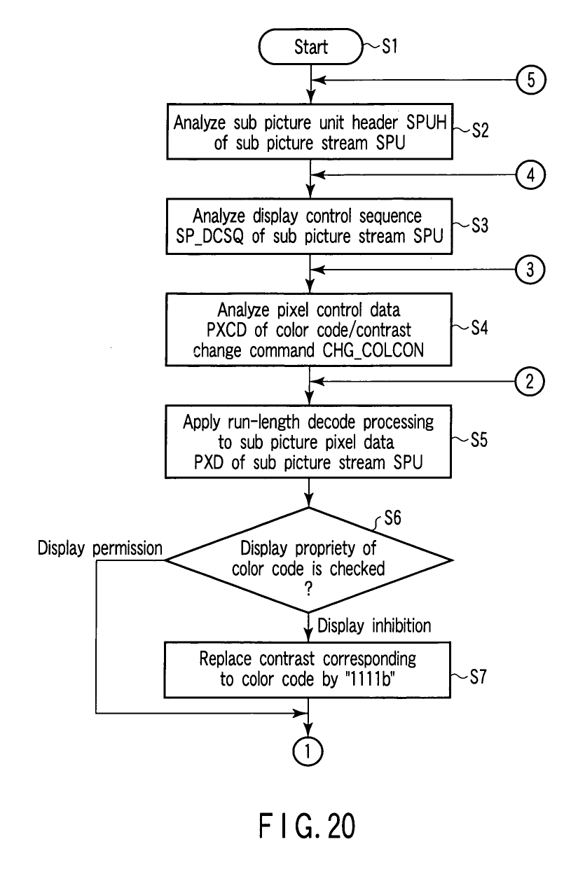

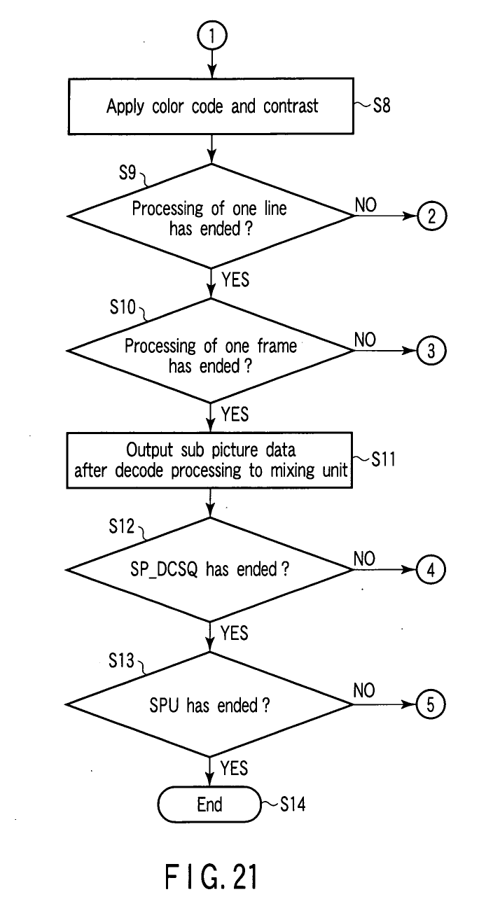

FIG. 20 and FIG. 21 each show flowcharts in which processing operations to control the propriety of displays for each color code are integrated, as mentioned above. If the processing is started (Step S1), the decoder unit 21 analyzes the sub picture unit header SPUH of the input sub video stream SPU in Step S2.

After this, in Step S3, the decoder unit 21 analyzes the display control sequence SP_DCSQ in turn from the input sub picture stream SPU on the basis of the information SP_DCSQT_SA showing the record start position of the display control sequence table SP_DCSQT existing in the previously analyzed sub picture unit header SPUH.

Next, in Step S4, if the color code/contrast changing command CHG_COLCON exists in the previously analyzed display control sequence SP_DCSQ, the decoder unit 21 analyzes the pixel control data PXCD. The decoder unit 21, in Step S5, executes run-length decode processing on the sub picture pixel data PXD in the input sub picture stream SPU.

After this, in Step S6, the decoder unit 21 obtains the color code, in the color code setting command SET_COLOR or in the pixel control information PX_CTLI of the color code/contrast changing command CHG_COLCON setting command SET_COLOR, which is specified on the basis of the color code to be applied to the sub picture PXD that has been applied with the run-length decode processing thereto previously, namely, two-bit pixel data indicating the kind of the sub picture PXD (refer to FIG. 5), and checks the propriety of displays of the corresponding-sub pictures for each obtained color code.

If the inhibition of the display of the sub picture is set for the obtained color code, the decoder unit 21, in Step S7, replaces the contrast of the sub picture PXD corresponding to the color code, namely, the contrast in the color code setting command SET_COLOR or in the pixel control information PX_CTLI of the color code/contrast changing command CHG_COLCON, for example, by “1111b” as a value which makes the display of the sub picture invisible on the main picture.

After this, the decoder unit 21, in Step S8, applies the color code and the contrast described in the color code setting command SET_COLOR, in the contrast setting command SET_CONTR, or in the pixel control information PX_CTLI of the color code/contrast changing command CHG_COLCON to the sub picture PXD of which the contrast has not been replaced by “1111b” in Step S7.

If the permission of the display of the sub picture for the color code obtained in Step S6 has been set, the decoder unit 21 directly shifts to processing in Step S8 without having to pass though the processing in Step S7. In this case, the color code and the contrast, which is described in the color code setting command SET_COLOR, in the contrast setting command SET_CONTR, or in the pixel control information PX_CTLI of the color code/contrast changing command CHG_COLCON specified on the basis of the two-bit pixel data indicating the kind (refer to FIG. 5), are applied as they are to the sub picture PXD which has been applied with the run-length decode processing in Step S5.

Then, the decoder unit 21 determines whether or not the processing of one line has ended in Step S9. If it is determined that the processing has not ended (NO, in Step S9), the decoder unit 21 returns to the processing in Step S5 to execute the run-length processing for the sub picture PXD. If it is determined that the processing of one line has ended (YES, in Step S9), the decoder unit 21 determines whether or not the processing of one frame has ended in Step S10. If it is determined that the processing has not ended (NO, in Step 10), it is determined that a plurality of items pf pixel control data PXCD of the color code/contrast changing command CHG_COLCON exist, and the decoder 21 returns to the processing in Step 4 to analyze the next pixel control data PXCD. The processing of one line is performed for the fields of TOP/BOTTOM.

If it is determined that the processing of one frame has ended (YES, in Step S10), after outputting the decoded sub picture data of one frame to the mixing unit 20 in Step S11, the decoder unit 21 determines whether or not the display control sequence SP_DCSQ has completed in Step S12. If it is determined that the sequence SP_DCSQ has not completed (NO, in Step S12), the decoder unit 21 returns to the processing in Step S3 to analyze the next display control sequence SP_DCSQ.

If it is determined that the sequence SP_DCSQ has completed (YES, in Step S12), the decoder unit 21 determines whether or not the sub picture stream SPU has ended in Step S13. If it is determined that the stream SPU has not ended (NO, in Step S13), the decoder unit 21 returns to the processing in Step S2 to analyze the sub picture unit header SPUH of the next sub picture stream SPU, and if it is determined that the stream SPU has ended (YES, in Step S13), the decoder unit 21 terminates the processing (Step S14).

According to the given embodiment, since the disk reproducing device may set the propriety of displays by color codes for various kinds of sub picture pixel data PXD included in one sub picture stream SPU, the device may enhance the degree of freedom of the display form of the sub pictures in addition to enhancing the means to select and reproduce a desired sub picture stream among a plurality of sub picture streams pre-recorded on the optical disk 12, and may also contribute the expansion of video expression.

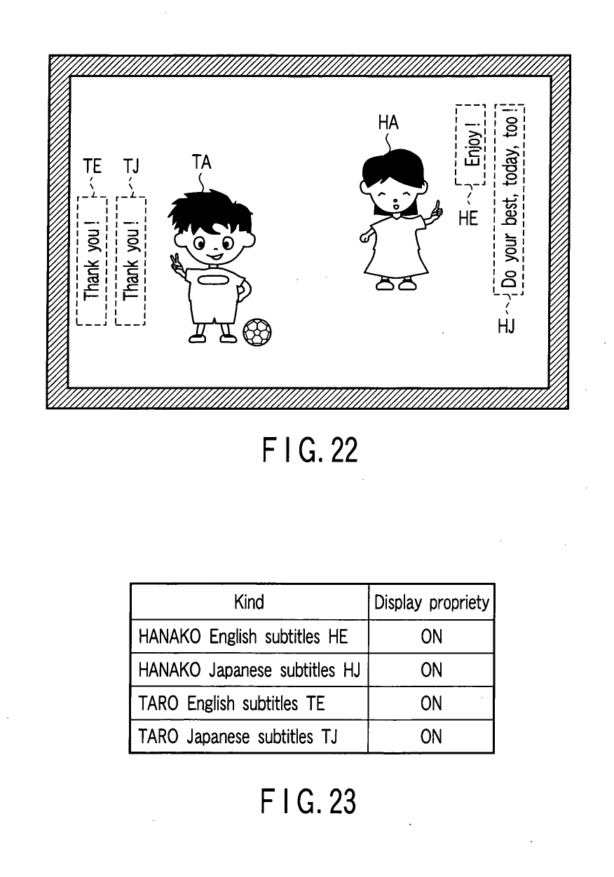

The following will describe an example of a concrete method of operation using the propriety of setting the propriety of displays by color code for various sub pictures included in one sub video stream SPU. As shown in FIG. 22, it is assumed that a main picture stream in which HANAKO HA and TARO TA are displayed and one sub picture stream SPU including Japanese subtitles HJ and English subtitles HE for HANAKO HA and Japanese subtitles TJ and English subtitles TE for TARO TA as a sub picture are recorded on the optical disk 12.

In this case, different color codes are set, respectively, for the four kinds of subtitles, namely for each sub picture pixel data PXD corresponding to the Japanese subtitles HJ for HANAKO HA, the English subtitles HE for HANAKO HA, the Japanese subtitles TJ for TARO TA and the English subtitles TE for TARO TA. For instance, it is assumed that the Japanese subtitles HJ for HANAKO HA are colored in red, the English subtitles HE for HANAKO HA are colored in pink, the Japanese subtitles TJ for TARO TA are colored in blue, and the English subtitles TE for TARO TA are colored in green.

In such a state, if the device displays a menu as shown in FIG. 23 and sets the permission of displays (ON) for all four kinds of subtitles, all four kinds of subtitles HJ, HE, TJ and TE are superposed on the main picture and displayed simultaneously, as shown in FIG. 22.

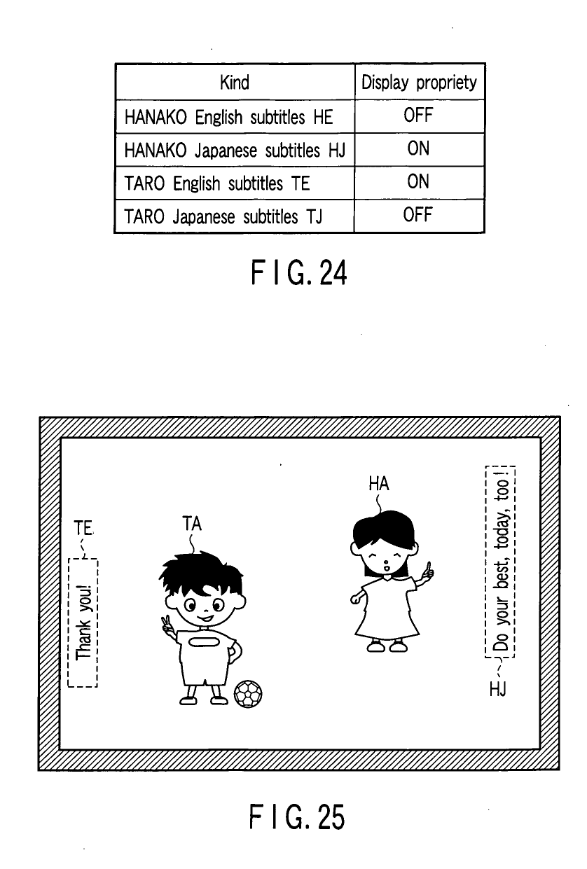

In contrast, as shown in FIG. 24, it is assumed that the user sets the English subtitles HE for HANAKO HA and the Japanese subtitles TJ for TARO TA to inhibited display (OFF). As mentioned above, then, the contrast of the sub picture pixel data PXD corresponding to the pink color code, which is the English subtitles HE for HANAKO HA and the blue color code, which is the Japanese subtitles TJ of TARO TA, is replaced by the value (e.g., “1111b”), which makes the display of the sub picture invisible on the main picture. Thereby, as shown in FIG. 25, the Japanese subtitles HJ for HANAKO HA and the English subtitles TE for TARO TA are superposed on the main picture and displayed simultaneously.

Therefore, since the reproducing device makes it possible not to display solely the sub picture corresponding to the color code specified not to be displayed of the identical sub picture streams, the device may control the propriety of displays of sub pictures by pixel, may enhance the degree of freedom in the expression of sub pictures, and may contribute to the expansion of video expression.

In the aforementioned embodiment, since two-bit is set as the pixel data indicating the kinds of the sub picture PXD (refer to FIG. 5); the device may utilize the subtitles colored in four colors per frame. However, in the case of DVD with HD, there is a format in which eight-bit pixel data, which indicates the kind of the sub picture PXD, is compressed, in accordance with different run-length compression rules, and the color codes may be set to 256 kinds.

Preparing subtitles for each of the background pixel, the pattern pixel, the emphasis pixels 1 and 2, and switching them by the color code setting command SET_COLOR and rewriting them by the setting of the color code/contrast changing command CHG_COLCON in the same kinds of pixel are possible approaches. It is acceptable to enable setting the propriety of displays of the sub pictures not only by the color code but also by the combination of color code and contrast.

As for a means for bringing the sub picture of the specified color code into a display inhibition state, other than the method for switching the contrast as mentioned above, a method, for example, which outputs a control signal to enable display-controlling by pixel from the sub picture decoder unit 21 to the mixing unit 20 to utilize the control signal, is also possible.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A sub picture reproducing device comprising:
an input unit configured such that a sub picture stream is provided with display control information comprising sub picture pixel data to be displayed and color codes for specifying display colors of the pixel data;
a setting unit configured to set a propriety of displays of the sub video pixel data for each of the color codes by manipulating the sub picture stream input to the input unit; and
a processing unit configured to apply prescribed decoding to the sub picture stream to the input unit;
wherein the processing unit is configured to control display inhibition of sub picture color codes accordingly to the display inhibition propriety set by the setting unit.

2. The device of claim 1, wherein
the display control information comprises information for specifying a contrast level of the sub picture pixel data to a main picture; and wherein
the processing unit is configured to replace a value for specifying the contrast level of the sub picture pixel data corresponding to the color codes set to display inhibition by the setting unit with a value for disabling a display of the sub picture on the main picture.

3. The device of claim 1, wherein the setting unit is configured to display a menu for selectively setting each propriety of displays to each color code comprised in the display control information.

4. A sub picture reproducing method comprising:
inputting a sub picture stream provided with display control information comprising sub picture pixel data to be displayed and color codes for specifying display colors of the pixel data;
setting a propriety of displays of the sub picture pixel data for each of the color codes by manipulating the sub picture stream input in the first step; and
applying prescribed decoding to the sub picture stream input and controlling display inhibition to sub picture pixel data corresponding to color codes set to display inhibition in the second step.

5. The method of claim 4, wherein
the display control information comprises information for specifying a contrast level of the sub picture pixel data to a main picture; and
wherein controlling comprises replaceing a value for specifying the contrast level of the picture pixel data corresponding to the color codes set to the display inhibition in the second step with a value for disabling a display of the sub picture on the main picture.

6. The method of claim 4, wherein setting a propriety of displays comprises displaying a menu for selectively setting each propriety of displays to each color code comprised in the display control information.

7. A sub picture reproducing program configured in a computer to execute:
inputting a sub picture stream provided with display control information comprising sub picture pixel data to be displayed and color codes for specifying display colors of the pixel data;
setting a propriety of displays of the sub picture pixel data for each of the color codes by manipulating the sub picture stream input in the input step; and
applying prescribed decoding to the sub picture stream input in the input step and controlling display inhibition to sub picture pixel data corresponding to display inhibition propriety set to color codes in the setting unit.

8. The program of claim 7, wherein
the display control information comprises information for specifying a contrast level of the sub picture pixel data to a main picture; and
wherein controlling comprises replaceing a value for specifying the contrast level of the picture pixel data corresponding to the color codes set to the display inhibition in the setting step with a value for disabling a display of the sub picture on the main picture.

9. The program of claim 7, wherein setting a propriety of displays comprises displaying a menu for selectively setting each propriety of displays to each color code comprised in the display control information.
